(19) United States
(12) Patent Application Publication
(10) Pub. No.: US 2014/0197599 A1
(43) Pub. Date: Jul. 17, 2014

(54) SEALING ARRANGEMENT AND USE THEREOF

(71) Applicant: Carl Freudenberg KG, Weinheim (DE)

(72) Inventors: Olaf Nahrwold, Ludwigshafen (DE); Thomas Jaeck, Fuerth (DE); Markus Clemens, Reichelsheim (DE); Ernst Jakob, Rimbach (DE)

(21) Appl. No.: 14/154,212

(22) Filed: Jan. 14, 2014

(30) Foreign Application Priority Data
Jan. 15, 2013 (DE) 10 2013 000 514.0

(51) Int. Cl. F16J 15/34

(52) U.S. Cl. CPC F16J 15/34
USPC 277/307; 277/361

(57) ABSTRACT

A sealing arrangement includes a double seal for sealing two chambers which are to be sealed off from one another and are each filled with a medium to be sealed. The double seal includes a first sealing ring disposed on a first side of the double seal and a second sealing ring disposed on a second side of the double seal. Each of the sealing rings has at least one dynamically stressed sealing lip contacting a surface to be sealed of a first machine element in a sealing manner. The sealing lips are arranged such that there is an axial distance between the sealing lips of the first and second sealing rings that are axially closest to one another. The first machine element is movable backwards and forwards in a translatory manner with a stroke. The axial distance is greater than the stroke.

### CROSS-REFERENCE TO PRIOR APPLICATIONS

Priority is claimed to German Patent Application No. DE 10 2013 000 514.0, filed on Jan. 15, 2013, the entire disclosure of which is hereby incorporated by reference herein.

### FIELD

The invention relates to a sealing arrangement, comprising a double seal for sealing two chambers which are to be sealed off from one another and are each filled with a medium to be sealed, the double seal comprising two sealing rings which are arranged at the end face on both sides of the double seal, each sealing ring having at least one dynamically stressed sealing lip, the sealing lips, arranged closest axially next to one another, of the first sealing ring and of the second sealing ring being arranged with an axial distance from one another and the sealing lips contacting in a sealing manner a surface, to be sealed, of a first machine element which can be moved backwards and forwards in a translatory manner with a stroke.

### BACKGROUND

A sealing arrangement is known from EP 2 067 996 A1. This previously known sealing arrangement is used in a reciprocating fuel pump. In the axial direction, the double seal is very short, the stroke of the piston rod to be sealed being greater than the axial distance between the sealing lips of the first and second sealing rings.

In the dynamic sealing of the piston rod by the sealing lips, a small amount of the medium to be sealed is always carried through under the respective sealing lip. This small amount of medium to be sealed is required for the lubrication of the sealing lips on the piston rod to prevent undesirable extensive wear of the sealing lips and to ensure use characteristics which remain consistently good as far as possible during a long service life.

Due to the only very small axial distance between the sealing lips and the relatively great stroke of the piston rod, the media, to be sealed off from one another, are undesirably mixed together in the chambers to be respectively sealed when the sealing arrangement is used as intended. This undesirable intermixing of the media to be sealed is due to the fact that the surface, to be sealed, of the piston rod entrains the media which are to be sealed and are used in each case for lubricating the respective sealing lip, past the respective other sealing lip into the respective other chamber to be sealed due to the relatively great stroke, compared to the axial distance. This is very disadvantageous in particular for a sealing arrangement in a fuel pump and when the media to be sealed off from one another are engine oil and fuel. For example, if fuel is entrained into the engine oil, it dilutes the engine oil. This can lead to oil film breaks in the engine bearings, to a relatively high friction as a result thereof and to engine failure. Conversely, the entrainment of engine oil into the fuel can damage the injection system. Carbonisation can occur at the injection nozzles, as a result of which the efficiency of the injection system is reduced. This can also entail the malfunction of one or more injection nozzles.

### SUMMARY

In an embodiment, the present invention provides a sealing arrangement including a double seal for sealing two chambers which are to be sealed off from one another and are each filled with a medium to be sealed. The double seal includes a first sealing ring disposed at an end face on a first side of the double seal and a second sealing ring disposed at an end face on a second side of the double seal. Each of the sealing rings has at least one dynamically stressed sealing lip contacting a surface to be sealed of a first machine element in a sealing manner. The sealing lips are arranged such that there is an axial distance between the sealing lips of the first and second sealing rings that are axially closest to one another. The first machine element is movable backwards and forwards in a translatory manner with a stroke, wherein the axial distance is greater than the stroke of the first machine element.

### BRIEF DESCRIPTION OF THE DRAWINGS

The present invention will be described in even greater detail below based on the schematic figures illustrating exemplary embodiments. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a first embodiment of a sealing arrangement in which the ratio between axial distance and stroke is shown graphically, the sealing rings of the double seal merging integrally into one another,

FIG. 2 shows a second embodiment of the sealing arrangement in which the double seal is enclosed radially over the outer periphery by a static seal in the form of an O-ring,

FIG. 3 shows a third embodiment, similar to the embodiment of FIG. 1, a spacer being arranged between the sealing rings of the double seal,

FIG. 4 shows a fourth embodiment, similar to the embodiment of FIG. 2, the spacer being configured as a means to guide the first machine element in the second machine element,

FIG. 5 shows a fifth embodiment in which the double seal has sealing rings which are configured differently from one another,

FIG. 6 shows a sixth embodiment in which the sealing rings of the double seal are configured as identical parts and are joined in a form-locking manner with the spacer,

FIG. 7 shows a seventh embodiment, similar to the embodiment of FIG. 3, the spacer having a partial region which is flexible in the axial direction, and

FIG. 8 shows an eighth embodiment, similar to the embodiment of FIG. 2, the O-ring surrounding the outer periphery of the spacer as a static seal.

### DETAILED DESCRIPTION

In an embodiment, the present invention develops a sealing arrangement of the previously known type such that the media, to be sealed off from one another, are reliably prevented from intermixing and such that nevertheless the sealing rings can still be adequately lubricated.

In an embodiment, it is provided that the axial distance between the sealing lips, arranged closest axially next to one another, of the first sealing ring and of the second sealing ring is greater than the stroke of the first machine element.

A configuration of this type prevents medium which is to be sealed and is used for lubricating the respective sealing lip from passing into the respective other chamber to be sealed past the sealing lip of the respective other sealing ring, due to the translatory backwards and forwards movement of the first machine element. Before the medium which is to be sealed and is located on the surface, to be sealed, of the first machine element to be sealed reaches the respective other sealing lip, the direction of movement of the first machine element changes into the opposite direction. This measure reliably prevents an intermixing of the media to be sealed inside the two chambers which are to be sealed off from one another.

According to an advantageous configuration, the ratio between axial distance and stroke can be at least 1.1. Subject to the respective wetting behaviour of the two media to be sealed, the ratio between axial distance and stroke can be selected to be higher, for example 2. Good wetting is achieved when the ratio between axial distance and stroke is configured to be relatively higher. However, in this respect, it should be noted that a greater installation space will also be required due to a higher ratio. Here, it is a matter of finding a sensible compromise between the highest possible ratio and yet a compact installation space.

When there is good wetting behaviour, the medium to be sealed starts to “creep up” the machine element to be sealed. The wetting behaviour is temperature dependent. However, poorer wetting behaviour occurs when the ratio between axial distance and stroke is configured to be relatively lower.

According to a first configuration, the sealing rings of the double seal can be configured such that they merge integrally into one another. As a result, the double seal is constructed with a particularly small number of parts and can be produced in a simple and cost-effective manner.

According to another configuration, the double seal can comprise a spacer which is arranged axially between the sealing rings, is produced separately and is in the form of a hollow cylinder. In this respect, it is advantageous that the spacer between the sealing rings can consist of a simple, economical material. The spacer can preferably consist of a polymeric material. For example, a polyamide material can be used. Thus, in a configuration of this type, flexible rubber sealing materials are used only for the production of the sealing rings.

The spacer can rest against the surface to be sealed and can have a first guide surface which rests against a second guide surface, radially facing the spacer, of a second machine element which is adjacently associated with the first machine element, with a radial distance. In such a case, the first machine element, which can be a piston rod for example, is guided by the spacer in the second machine element, which can be a housing for example.

The second machine element can be formed by a housing, for example, which surrounds the outer periphery of the first machine element. Due to the comparatively long axial length of the double seal, it is important for the first machine element to be guided effectively in terms of the double seal. Any tilting of the first machine element in terms of the double seal would adversely affect the operation and the service life of the double seal.

The spacer can preferably consist of materials which are used for linear guide means. Materials of this type can be, for example, polymeric materials such as PTFE. The spacer can also consist of sintered bronze or ceramic materials.

The spacer can have a partial region which is configured to be flexible in the axial direction. The double seal is usually fitted in the sealing arrangement without any clearance in the axial direction. When the sealing arrangement is used as intended, the double seal can heat up which results in thermal expansion in the axial direction. The partial region which is flexible in the axial direction is provided to prevent an undesirably great tension of the double seal, induced by temperature, in the axial direction. The spacer is resiliently compressed in the axial direction to the extent by which the double seal would expand in the axial direction as a result of heating up. Consequently, the double seal is always arranged without any clearance in its installation space during the entire service life of the sealing arrangement.

The spacer and the sealing rings can be joined together in a force-locking and/or form-locking manner. Alternatively, the spacer can be joined with the sealing rings in a material-uniting manner. It is advantageous if the sealing rings jointly form a pre-assemblable unit by virtue of their connection with the spacer. The number of loose parts is reduced thereby and the assembly of the sealing arrangement is simplified. A combination of the mentioned joining methods is also possible, subject to the respective application. A form-locking join of the spacer with the two sealing rings has the advantage that the spacer and the sealing rings can be released non-destructively. This measure means that after the sealing arrangement has been used, it can be easily recycled with the components sorted according to type.

The sealing rings can be configured as identical parts, being formed in a mirror-inverted manner to an imaginary radial plane arranged axially in the center of the double seal. Consequently, production and assembly of the double seal are particularly simple.

According to another configuration, the sealing rings can be formed differently from one another and/or consist of different materials. Thus, the sealing rings can be adapted particularly effectively to the respective application, in particular to the medium to be sealed in each case. For sealing engine oil, the sealing ring can preferably consist of, for example, fluorinated rubber FKM, acrylate rubber ACM, acrylonitrile-butadiene rubber NBR or a hydrogenated acrylonitrile-butadiene rubber HNBR. The advantage of these materials is that upon contact with the media to be sealed, they do not exhibit any swelling, or only slight swelling.

Fuels can preferably be sealed, for example by sealing rings of polytetrafluorethylene PTFE, PTFE compounds, i.e. PTFE with fillers, such as bronze, or polyether ketone PEEK. Here again, these materials have the advantage that upon contact with the media to be sealed, they do not exhibit any swelling, or only slight swelling.

Based on the appropriate choice of material for the respective application, it is possible to choose the most economical of the suitable materials in each case. Expensive PTFE materials do not have to be used for a simple seal; consequently, the sealing arrangement can be produced economically.

The double seal can have at least one statically stressed seal which contacts the second machine element in a sealing manner. The statically stressed seal can compensate coaxial errors between the first and second machine elements. A false position of the two machine elements relative to one another is then not transferred to the sealing lips of the sealing rings. Undesirably high mechanical stresses of the sealing lips are avoided thereby.

The static seal can be formed by an O-ring. Due to its soft and resilient behaviour, the O-ring corrects coaxial errors which may exist between the two machine elements and it seals on the static side of the sealing rings. It is possible for two or more O-rings to be used to prevent the double seal from tilting. O-rings are economical and are available in many sizes. However, in general it is also possible to use sealing rings having different cross sections as the static seal, for example X-rings.

The O-ring can be arranged in a recess which is open radially in the direction of the second machine element, in the double seal. In this respect, it is possible for the open recess to be arranged in a double seal in which sealing rings are configured such that they merge integrally into one another or are joined together by a spacer.

Each sealing ring can have a statically stressed seal which is configured as a toric thickening on the side radially facing the second machine element. Toric thickenings of this type can also be used in combination with the previously described O-ring.

Viewed in section, the sealing rings of the sealing arrangement can be, for example, substantially C-shaped, open in the axial direction. The dynamically stressed sealing lips and the toric thickenings can be arranged at the end face in the region of the free sides, the sealing lips and the thickenings resting against the machine element to be respectively sealed with resilient prestress due to the C-shaped form of the sealing rings. To increase the radial contact pressing force of the sealing lips and of the thickenings on the respective machine element, for example a C-shaped splay spring can be arranged in the cavity of the sealing rings, which spring prestresses the free sides radially in the direction of the adjoining machine elements to be sealed.

The first machine element can be formed by a piston rod and the second machine element can be formed by a housing which surrounds the first machine element with a radial distance. Accordingly, the dynamically stressed sealing lips are then configured to seal radially inwards and the toric thickenings are configured to seal radially outwards.

The previously described sealing arrangement can be used in a reciprocating fuel pump, in which case one of the chambers to be sealed is filled with fuel and the other chamber to be sealed is filled with oil. The reciprocating fuel pump can be used together with an internal combustion engine in a motor vehicle.

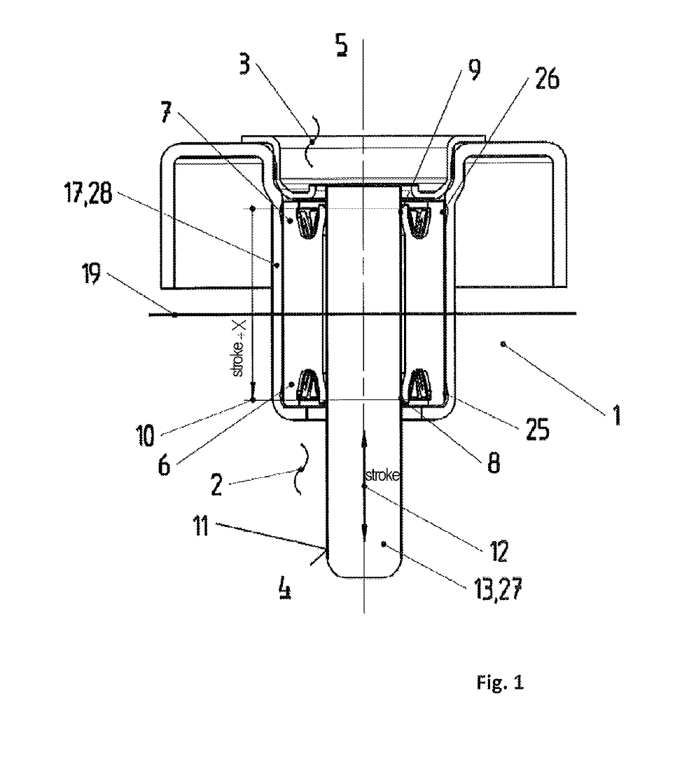

FIGS. 1 to 8 show eight embodiments of a sealing arrangement which comprises a double seal 1 for sealing two chambers 4, 5 which are to be sealed off from one another. The sealing arrangement is used in a reciprocating fuel pump. The first machine element 13 is configured as a piston rod 27 and the second machine element 17 is configured as a housing 28. One of the chambers 4 to be sealed is filled with fuel and the other chamber 5 to be sealed is filled with engine oil. The fuel can be petrol or diesel, for example.

The double seal 1 comprises the two sealing rings 6, 7 which are arranged axially in a mutually opposite direction, to seal the chambers 4, 5. The sealing rings 6, 7 have the dynamically stressed sealing lips 8, 9 which enclose in a sealing manner the outer periphery of the surface 11 to be sealed of the first machine element 13, formed by the piston rod 27. The sealing lip 8 of the first sealing ring 6 is adjacently associated with the sealing lip 9 of the second sealing ring 7 with an axial distance 10 which is greater than the stroke 12 of the machine element 13 which can move backwards and forwards in a translatory manner.

If more than one dynamically stressed sealing lip 8, 9 is used in each case per sealing ring 6, 7, the axial distance 10 is the distance between the sealing lips of the first sealing ring 6 and of the second sealing ring 7 which are arranged closest axially next to one another.

In the embodiments shown here, the ratio between axial distance 10 and stroke 12 is 1.3.

The fact that the axial distance 10 between the sealing lips 8, 9 is greater than the stroke 12 of the first machine element 13 means that medium 2, 3, which is to be sealed and is required for lubricating the sealing lip 8, 9, is prevented from being entrained by the surface 11, to be sealed, out of the chamber 4, 5 to be sealed, past the sealing lip 9, 8 into the chamber 5, 4 to be sealed and from being mixed there with the medium 3, 2 to be sealed. This also applies the other way round. The medium 3, 2, to be sealed, from the chamber 5,4 to be sealed is also not carried through under the sealing lip 8, 9 into the chamber 4, 5 to be sealed when the sealing arrangement is used as intended and is not mixed there with the medium 2, 3 to be sealed.

FIG. 1 shows a first embodiment of the sealing arrangement. The sealing rings 6, 7 of the double seal 1 are configured to merge integrally into one another, the dynamic sealing action being achieved on the surface 11 of the first machine element 13 by the sealing lips 8, 9 and the static seal being achieved on the second machine element 17 by the toric thickenings 25, 26. The sealing rings 6, 7 merge integrally into one another and are formed from the same material.

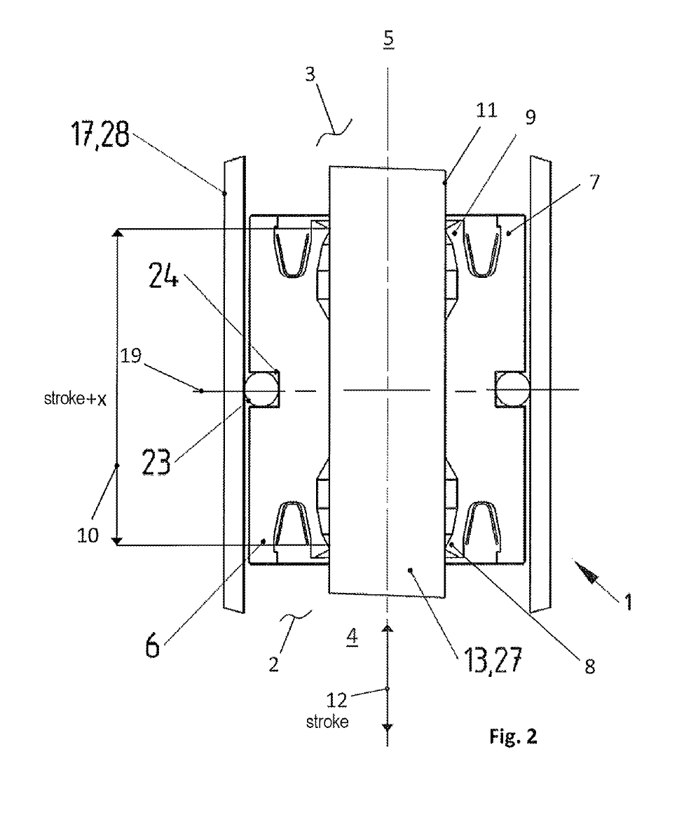

FIG. 2 shows a second embodiment of a sealing arrangement which substantially differs from the first embodiment from FIG. 1 in that a recess 24 which is open radially in the direction of the second machine element 17 and in which an O-ring 23 is arranged is provided in the axial direction between the sealing rings 6, 7 of the double seal 1. The resilient O-ring 23 corrects possible coaxial errors between the machine elements 13, 17 which are to be sealed off from one another.

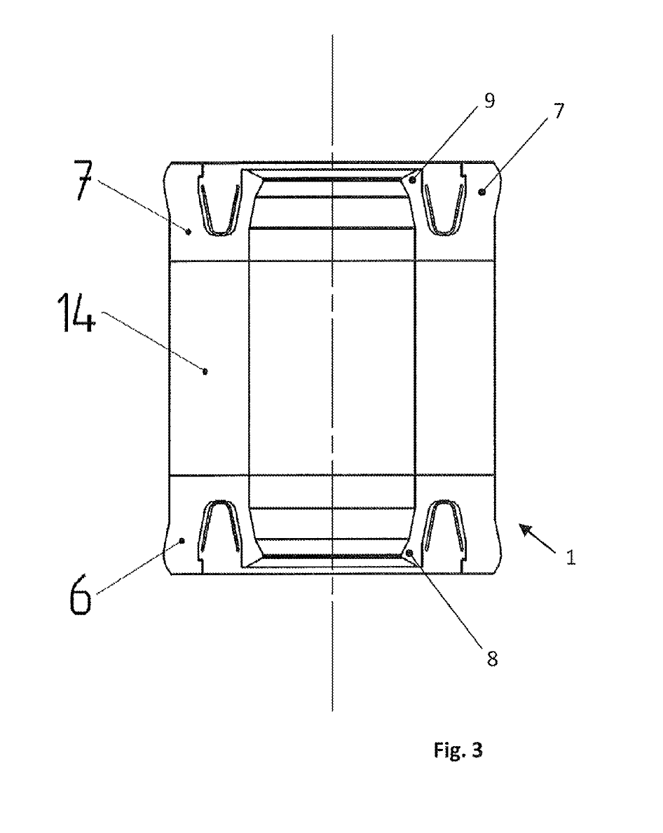

FIG. 3 shows a third embodiment, similar to the embodiment from FIG. 1, the sealing rings 6, 7 being joined together by the separately produced spacer 14 which is in the form of a hollow cylinder and consists here of a polymeric material. As also in the other embodiments which are configured in multiple parts, the sealing rings 6, 7 and the spacer 14 can be joined together in a different way and can form a pre-assemblable unit. The join can be made in a force-locking and/or form-locking manner or in a material-uniting manner, and combinations are also possible.

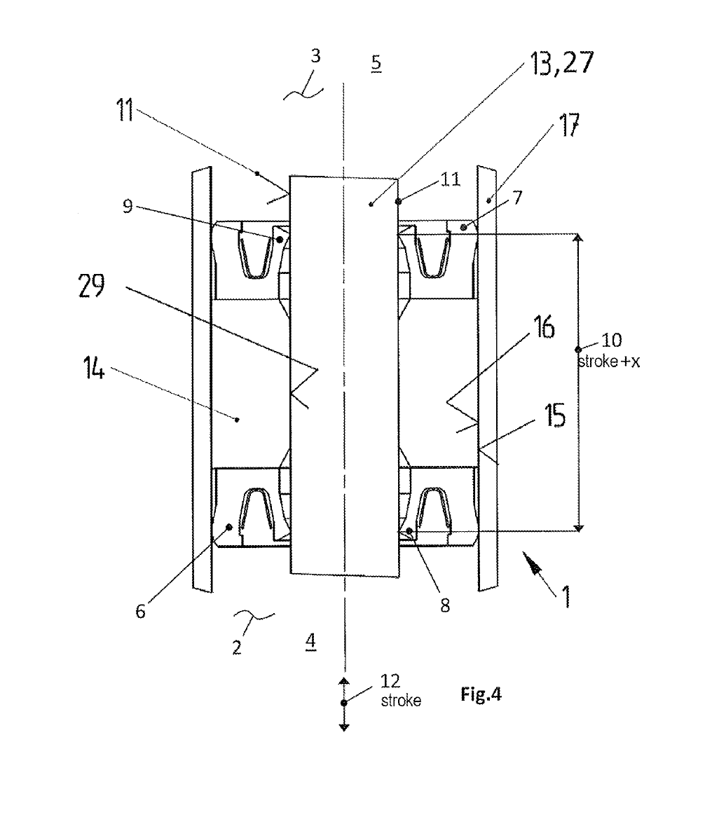

FIG. 4 shows a fourth embodiment in which the spacer 14 is configured as a guide sleeve. The spacer 14 surrounds the surface 11 of the first machine element 13, resting on the outer periphery thereof and is enclosed by the second machine element 17 which rests on the outer periphery thereof. The double seal is thereby associated concentrically both with the first machine element 13 and with the second machine element 17; this measure reliably prevents the double seal 1 from tilting.

The spacer 14 has a first guide surface 15 which rests against a second guide surface 16 of the second machine element 17. The spacer 14 has radially on the inside a further guide surface 29 which surrounds the surface 11, to be sealed, of the first machine element 13 while resting thereon.

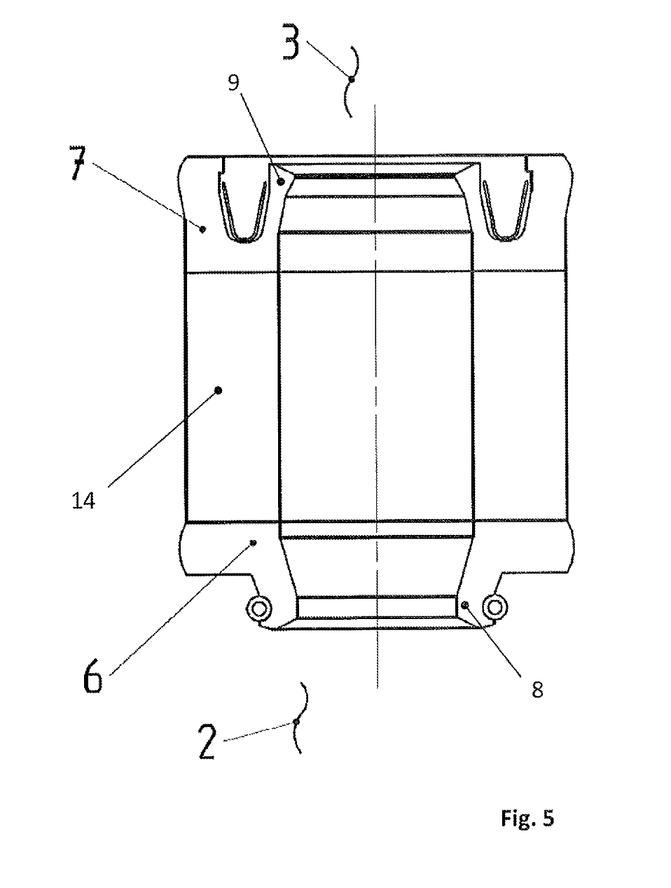

FIG. 5 shows a fifth embodiment which differs from the embodiment from FIG. 3 in that the sealing rings 6, 7 are configured differently from one another and they each consist of a sealing material which is particularly well suited to sealing the media 2, 3 to be sealed. In the embodiment shown here, an FKM material is used on the engine oil side, and a PTFE material is used on the fuel side.

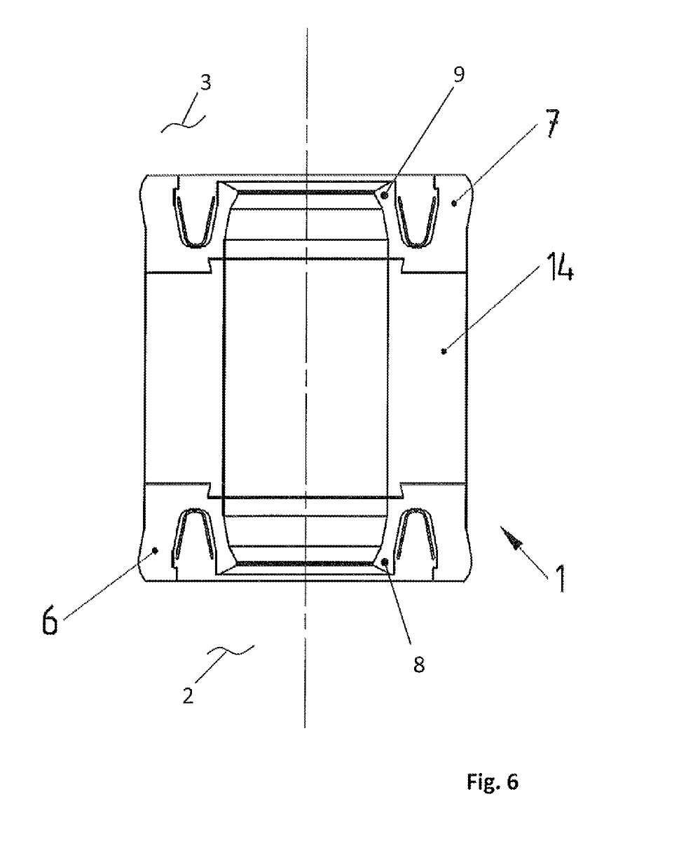

FIG. 6 shows a sixth embodiment in which the sealing rings 6, 7 are joined to the spacer 14 by a form-locking connection, configured in dovetail form. Should the retaining force of this form-locking connection be inadequate in holding together the double seal 1 during the intended use of the sealing arrangement, it is possible to additionally provide a material-uniting connection, for example using a thermal and/or chemical joining method.

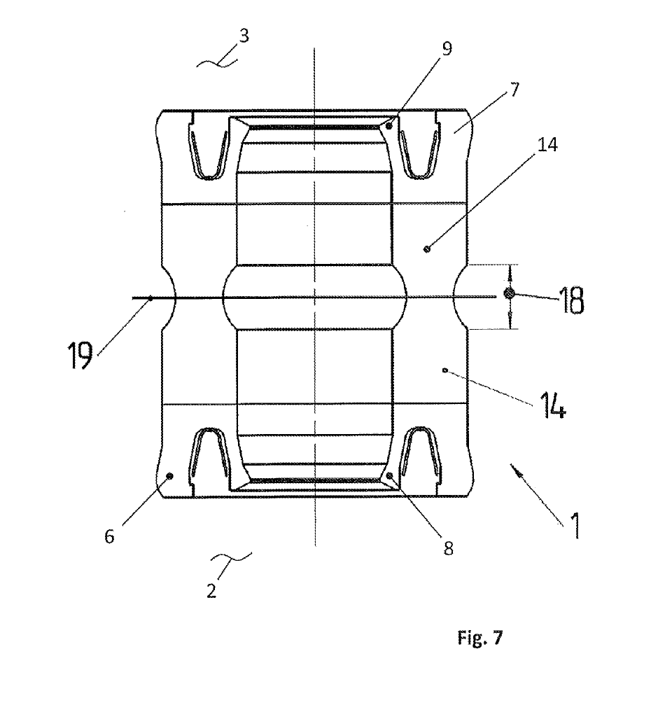

FIG. 7 shows a seventh embodiment of the sealing arrangement, similar to the third embodiment from FIG. 3, the spacer 14 having a partial region 18 which is flexible in the axial direction. This partial region 18 is arranged axially in the center of the double seal 1 and is intersected centrally by the radial plane 19. This partial region is provided to compensate for the thermal expansion of the sealing arrangement in the axial direction, to prevent undesirably great tension or an arrangement of the double seal with clearance in the sealing arrangement.

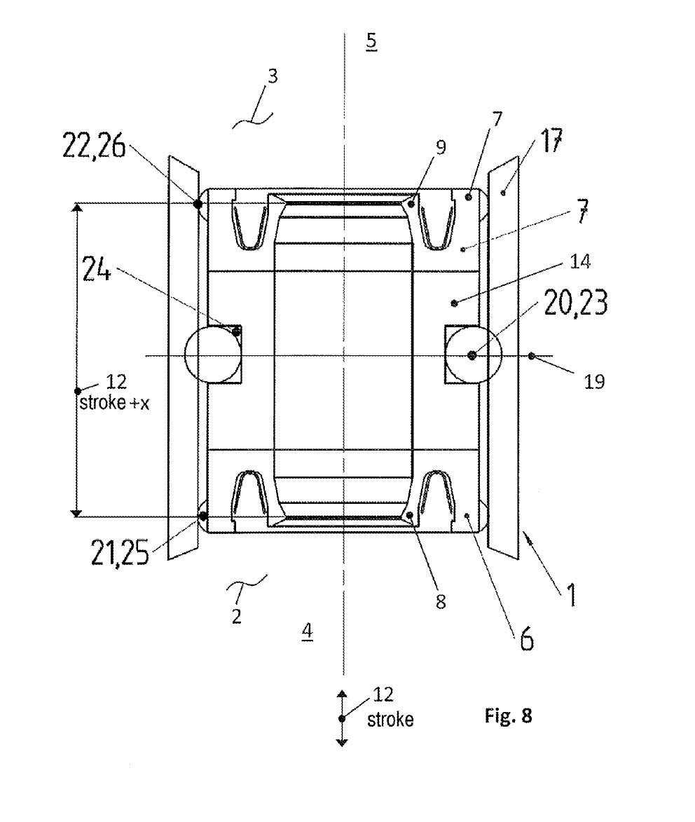

FIG. 8 shows an eighth embodiment of the sealing arrangement according to the invention which substantially shows a combination of the third embodiment from FIG. 3 with the second embodiment from FIG. 2. Arranged axially in the center of the double seal 1 is the recess 24 for the O-ring 23 which seals statically with respect to the second machine element 17.

In the embodiment shown here, the double seal 1 has three statically stressed seals 20, 21, 22 which contact the second machine element 17 in a statically sealing manner in each case. One static seal 20 is formed by the O-ring 23 and the two other static seals 21, 22 are formed by toric thickenings 25, 26 which form components of the respective sealing rings 6, 7.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A sealing arrangement, comprising:
a double seal for sealing two chambers which are to be sealed off from one another and are each filled with a medium to be sealed, the double seal including a first sealing ring disposed at an end face on a first side of the double seal and a second sealing ring disposed at an end face on a second side of the double seal, each of the sealing rings having at least one dynamically stressed sealing lip contacting a surface to be sealed of a first machine element in a sealing manner, the sealing lips being arranged such that there is an axial distance between the sealing lips of the first and second sealing rings that are axially closest to one another, the first machine element being movable backwards and forwards in a translatory manner with a stroke, wherein the axial distance is greater than the stroke of the first machine element.

2. The sealing arrangement according to claim 1, wherein a ratio between the axial distance and the stroke is at least 1.1.

3. The sealing arrangement according to claim 1, wherein the sealing rings of the double seal are configured to merge integrally into one another.

4. The sealing arrangement according to claim 1, wherein the double seal comprises a separately produced spacer having a shape of a hollow cylinder arranged between the sealing rings.

5. The sealing arrangement according to claim 4, wherein the spacer rests against the surface to be sealed and has a first guide surface which rests against a second guide surface, radially facing the spacer, of a second machine element which is adjacently associated with the first machine element, with a radial distance.

6. The sealing arrangement according to claim 4, wherein the spacer consists of a polymeric material.

7. The sealing arrangement according to claim 4, wherein the spacer has a partial region which is flexible in the axial direction.

8. The sealing arrangement according to claim 4, wherein the spacer and the sealing rings are joined together in at least one of a force-locking and a form-locking manner.

9. The sealing arrangement according to claim 4, wherein the spacer and the sealing rings are joined together in a material-uniting manner.

10. The sealing arrangement according to claim 3, wherein the sealing rings are identical parts and are mirror-inverts of one another with respect to an imaginary radial plane arranged axially in the center of the double seal.

11. The sealing arrangement according to claim 3, wherein the sealing rings are configured differently from one another or consist of different materials.

12. The sealing arrangement according to claim 1, wherein the double seal has at least one statically stressed seal which contacts a second machine element in a sealing manner.

13. The sealing arrangement according to claim 12, wherein the static seal is formed by an O-ring.

14. The sealing arrangement according to claim 13, wherein the O-ring is arranged in a recess, open radially in a direction of the second machine element, in the double seal.

15. The sealing arrangement according to claim 1, wherein each of the sealing rings has a statically stressed seal configured as a toric thickening on a side radially facing a second machine element.

16. The sealing arrangement according to claim 1, wherein the first machine element is formed by a piston rod and a second machine element is formed by a housing enclosing the first machine element with a radial distance.

17. A method of using a sealing arrangement, comprising:
filling a first chamber with fuel;
filling a second chamber with oil;
providing a double seal so as to seal the chambers from one another, the double seal including a first sealing ring disposed at an end face on a first side of the double seal and a second sealing ring disposed at an end face on a second side of the double seal, each of the sealing rings having at least one dynamically stressed sealing lip contacting a surface to be sealed of a first machine element in a sealing manner, the sealing lips being arranged such that there is an axial distance between the sealing lips of the first and second sealing rings that are axially closest to one another, the first machine element being movable backwards and forwards in a translatory manner with a stroke, wherein the axial distance is greater than the stroke of the first machine element.
